(19) United States
(12) Patent Application Publication
(10) Pub. No.: US 2026/0266468 A1
(43) Pub. Date: Sep. 10, 2026

(54) METHOD FOR SETTING A TARGET CORE TEMPERATURE IN A COOKING APPLIANCE

(71) Applicant: ILLINOIS TOOL WORKS INC., Glenview, IL (US)

(72) Inventors: Fabrice AMARI, Breuilpont (FR); Luc BUSET, Poligny (FR)

(21) Appl. No.: 19/166,713

(22) PCT Filed: Mar. 20, 2024
(86) PCT No.: PCT/US2024/020611

§ 371 Date: Sep. 18, 2025

(30) Foreign Application Priority Data
Mar. 23, 2023 (FR) FR2302748

(51) Int. Cl. F24C 7/08; G01K 1/02; G01K 1/024

(52) U.S. Cl. CPC F24C 7/085; G01K 1/024; G01K 1/026; G01K 2207/06

(57) ABSTRACT

A cooking appliance with a control system including a core probe for measuring a core temperature of an item to be cooked, a user interface and a controller operationally connected to the core probe and to the user interface. The controller is configured to receive, via the user interface, product parameters for an item to be cooked, and to display, via the user interface, a suggested target core temperature determined at least in part from the product parameters received via the user interface.

### TECHNICAL FIELD

The invention generally relates to the field of cooking appliances and more specifically to cooking appliances incorporating a core temperature probe in which a target core temperature can be set to control a cooking cycle. More specifically, but not exclusively, the present invention relates to a method for setting a target core temperature in such a cooking appliance. The present invention also relates to a computer program for executing the method, a system for controlling a cooking appliance and a cooking appliance in which the method can be implemented.

### BACKGROUND

It is common practice to provide a system for controlling a cooking appliance that enables a user to set a core temperature and control a cooking cycle based in part on this core temperature setting.

Some of these cooking appliances can be used in manual mode by experienced chefs, since cooking parameters such as temperature, humidity, fan speed and others can be set and changed by the chef during the cooking cycle to obtain a cooked item with the desired characteristics. In such situations, the core temperature provides an indication of the item's degree of doneness.

It is also common practice to provide cooking appliances with control systems that operate in automatic mode, in which the characteristics of the item to be cooked are selected by a user, together with the desired final characteristics of the cooked item. The control system then sets all the cooking parameters for the cooking cycle.

### SUMMARY

The invention aims to facilitate the selection of an appropriate core temperature when operating a cooking appliance in manual mode, while allowing the chef to customize the cooking cycle. The invention also aims to provide a system for controlling cooking appliances that is more convenient than the known systems.

The invention relates to a method for setting a target core temperature in a control system of a cooking appliance. The method can comprise receiving one or more product parameters for an item to be cooked. The method can comprise receiving the parameter(s) via a user interface in the control system. The method can comprise displaying, for example via the user interface, a suggested target core temperature that is determined at least in part from the product parameter(s) received via the user interface.

More specifically, the invention relates to a method for setting a target core temperature in a control system of a cooking appliance, the method comprising: receiving, via a user interface on the control system, one or more product parameters for an item to be cooked; displaying, via the user interface, a suggested target core temperature that is determined at least in part from the product parameter(s) received via the user interface.

The method can comprise receiving the parameter(s) in response to a user selection, which the user can select via the user interface on the control system.

The method can comprise receiving, for example via the user interface, a first of the product parameters for an item to be cooked. The method can comprise displaying, for example via the user interface, a series of possible second product parameters. The series of possible second product parameters can be based on the first product parameter. The method can comprise receiving, for example via the user interface, a selection of one in the series of possible second product parameters.

More specifically, the method can comprise: receiving, via the user interface, a first of the product parameters for an item to be cooked; displaying, via the user interface, a series of possible second product parameters based on the first product parameter; and receiving, via the user interface, a selection of one in the series of possible second product parameters.

The first product parameter can correspond to a type of food and the second product parameter corresponds to a degree of doneness.

The method can comprise receiving one or more cooking parameters via the user interface. The method can comprise determining the suggested target core temperature based on the cooking parameter(s) and/or on the product parameter(s) received via the user interface.

More specifically, the method can comprise: receiving a cooking parameter via the user interface; and determining the suggested target core temperature based on the cooking parameter and product parameters received via the user interface.

The invention also relates to a method for setting a target core temperature in a control system of a cooking appliance, the method comprising: receiving, via a user interface on the control system, a cooking parameter; receiving, via the user interface, one or more product parameters for an item to be cooked; determining a target core temperature that is suggested based on the cooking parameter and/or the product parameter(s) received via the user interface; and displaying, via the user interface, a suggested target core temperature.

The cooking parameter can comprise an ambient cooking appliance temperature. The method can comprise determining a target core temperature range associated with the product parameter(s) received via the user interface.

The target core temperature range can be associated with a cooking parameter range, for example associated with an ambient cooking appliance temperature range. The method can comprise determining the suggested target core temperature by determining a value in the target core temperature range that corresponds to the cooking parameter, for example that corresponds to the ambient cooking appliance temperature.

More specifically, the method can comprise: determining a target core temperature range associated with the product parameters received via the user interface; and determining the suggested target core temperature by determining a value within the target core temperature range that corresponds to the ambient cooking appliance temperature.

The method can comprise receiving, for example via the user interface, an adjustment of the suggested target core temperature. The method can comprise displaying, for example via the user interface, an adjusted target core temperature based on the adjustment received via the user interface.

More specifically, the method can comprise: receiving, via the user interface, an adjustment of the suggested target core temperature; and displaying, via the user interface, an adjusted target core temperature based on the adjustment received via the user interface.

The method can comprise receiving, for example via the user interface, an acceptance of the target core temperature displayed. The method can comprise saving the accepted target core temperature.

The method can comprise receiving a prompt via the user interface to start a cooking cycle. The method can comprise starting, for example in response to the prompt, a cooking cycle based on the accepted or saved target core temperature.

More specifically, the method can comprise: receiving, via the user interface, an acceptance of the target core temperature displayed; receiving, via the user interface, a prompt to start a cooking cycle; and starting, in response to the prompt, a cooking cycle based on the accepted target core temperature.

The method can comprise displaying, for example via the user interface, a target core temperature menu in response to a request received via the user interface. The method can comprise displaying the target core temperature menu prior to receiving the product parameter(s).

The method can comprise: customizing the target core temperature menu in response to a request received via the user interface.

The method can comprise retrieving, from a table, the suggested target core temperature associated with the product parameter(s) received via the user interface. The method can comprise retrieving, from a table, the target core temperature range associated with the product parameter(s) received via the user interface.

In addition, the values in the table can be automatically calculated and/or updated based on the cooking parameter(s) and on the target core temperature range associated with the product parameter(s) received via the user interface.

The method can comprise receiving user information, for example via the user interface. The method can comprise retrieving, for example from a table linked to the user information, the suggested target core temperature or the target core temperature range associated with the product parameter(s) received via the user interface. The method can comprise: saving one or more edited values in the table in response to a request received via the user interface.

The method can comprise automatically determining the location of the cooking appliance. The method can comprise retrieving, from a table linked to the location of the cooking appliance, the suggested target core temperature or the target core temperature range associated with the product parameter(s) received via the user interface.

The invention also relates to a cooking appliance control system. The cooking appliance control system can comprise a core probe for measuring a core temperature of an item to be cooked. The cooking appliance control system can comprise a user interface, which can be used to receive inputs from a user and/or display information. The cooking appliance control system can comprise a controller. The controller can be operationally connected to the core probe and/or to the user interface.

The controller can be configured to receive, for example via the user interface, one or more product parameters for an item to be cooked. The controller can be configured to display, for example via the user interface, a suggested target core temperature. The suggested target core temperature can be determined at least in part from the product parameter(s) received via the user interface.

More specifically, the invention also relates to a cooking appliance control system: a core probe for measuring a core temperature of an item to be cooked; a user interface which can be used to receive inputs from a user and to display information; and a controller operationally connected to the core probe and to the user interface; in which the controller is configured to: receive, via the user interface, one or more product parameters for an item to be cooked; and display, via the user interface, a suggested target core temperature that is determined at least in part from the one or more product parameters received via the user interface.

The controller can be configured to receive, for example via the user interface, a first of the product parameters for an item to be cooked. The controller can be configured to display, for example via the user interface, a series of possible second product parameters. The series of possible second product parameters can be based on the first product parameter. The controller can be configured to receive, for example via the user interface, a selection of one in the series of possible second product parameters.

More specifically, the controller can be configured to: receive, via the user interface, a first of the product parameters for an item to be cooked; display, via the user interface, a series of possible second product parameters based on the first product parameter; and receive, via the user interface, a selection of one in the series of possible second product parameters.

The first product parameter can correspond to a type of food and the second product parameter can correspond to a degree of doneness.

The controller can be configured to receive, for example via the user interface, one or more cooking parameters. The controller can be configured to determine the suggested target core temperature based on the cooking parameter(s) and/or on the product parameter(s) received via the user interface.

More specifically, the controller can be configured to: receive a cooking parameter via the user interface; and determine the suggested target core temperature based on the cooking parameter and product parameters received via the user interface.

The invention also relates to a cooking appliance control system comprising: a core probe for measuring a core temperature of an item to be cooked; a user interface which can be used to receive inputs from a user and to display information; and a controller operationally connected to the core probe and to the user interface; in which the controller is configured to: receive, via the user interface, a cooking parameter; receive, via the user interface, one or more product parameter(s) for an item to be cooked; determine a suggested target core temperature based on the cooking parameter and/or on the product parameter(s) received via the user interface; and display, via the user interface, the suggested target core temperature.

The cooking parameter can comprise an ambient cooking appliance temperature. The controller can be configured to retrieve a target core temperature range associated with the product parameter(s) received via the user interface. The target core temperature range can be associated with a cooking parameter range, for example associated with an ambient cooking appliance temperature range. The controller can be configured to determine the suggested target core temperature by determining a value in the target core temperature range that corresponds to the cooking parameter, for example that corresponds to the ambient cooking appliance temperature.

More specifically, the controller can be configured to: retrieve a target core temperature range associated with the product parameters received via the user interface; and determine the suggested target core temperature by determining a value within the target core temperature range that corresponds to the ambient cooking appliance temperature.

The controller can be configured to display a warning, for example an indicator, if the cooking parameter is outside the cooking parameter range for the product parameter(s) received via the user interface.

The controller can be configured to receive, via the user interface, an adjustment of the suggested target core temperature. The controller can be configured to display, for example via the user interface, an adjusted target core temperature based on the adjustment received via the user interface.

More specifically, the controller can be configured to: receive, via the user interface, an adjustment of the suggested target core temperature; and display, via the user interface, an adjusted target core temperature as a function of the adjustment received via the user interface.

The controller can be configured to receive, for example via the user interface, an acceptance of the target core temperature displayed. The controller can be configured to save the accepted target core temperature.

The controller can be configured to receive, for example via the user interface, a prompt to start a cooking cycle. The controller can be configured to start, for example in response to the prompt, a cooking cycle based on the accepted or saved target core temperature.

More specifically, the controller can be configured to: receive, via the user interface, an acceptance of the target core temperature displayed; receive, via the user interface, a prompt to start a cooking cycle; and start, in response to the prompt, a cooking cycle based on the target core temperature displayed.

The controller can be configured to display, for example via the user interface, a target core temperature menu in response to a request received via the user interface. The controller can be configured to display the target core temperature menu prior to receiving the product parameter(s).

The controller can be configured to: customize the target core temperature menu in response to a request received via the user interface.

The controller can be configured to: retrieve, from a table, the suggested target core temperature associated with the product parameter(s) received via the user interface. The controller can be configured to: retrieve, from a table, the target core temperature range associated with the product parameter(s) received via the user interface.

In addition, the values in the table can be automatically calculated and/or updated based on the cooking parameter(s) and on the target core temperature range associated with the product parameter(s) received via the user interface.

The controller can be configured to receive, for example via the user interface, user information. The controller can be configured to retrieve, for example from a table linked to the user information, the suggested target core temperature or the target core temperature range associated with the product parameter(s) received via the user interface. The controller can be configured to: save one or more edited values in the table in response to a request received via the user interface.

The controller can be configured to automatically determine the location of the cooking appliance. The controller can be configured to retrieve, from a table linked to the location of the cooking appliance, the suggested target core temperature or the target core temperature range associated with the product parameter(s) received via the user interface.

The controller can comprise a memory, for example on which one or more tables are stored. Each table can comprise suggested target core temperatures or target core temperature ranges associated with a plurality of product parameters. The controller can comprise a processor, which can be operationally connected to the memory and configured, for example, to retrieve, from one of the tables stored in the memory, a suggested target core temperature or a target core temperature range associated with the product parameter(s) received via the user interface.

More specifically, the controller can comprise: a memory on which one or more tables are stored, each table comprising suggested target core temperatures or target core temperature ranges associated with a plurality of product parameters; and a processor operationally connected to the memory and configured to retrieve, from one of the tables stored in the memory, a suggested target core temperature or a target core temperature range associated with the product parameter(s) received via the user interface.

The user interface can comprise a touch screen.

The touch screen can be configured to display a plurality of icons each representing a respective product parameter for selection by a user. The touch screen can be configured to display an indicator of the user-selected ambient temperature of the cooking appliance.

The invention also relates to a cooking appliance comprising the aforementioned cooking appliance control system.

The invention also relates to a computer program comprising a computer-readable program code for prompting the execution by a processor of a procedure for implementing the aforementioned method.

The cooking appliance can comprise an oven.

For the avoidance of doubt, all the features described herein also apply to any aspect of the invention.

As part of this application, it is expressly provided that the various aspects, embodiments, examples and alternatives disclosed in the preceding paragraphs, in the claims and/or in the following description and drawings, and in particular the individual features thereof, may be taken separately or in any combination. In other words, all embodiments and/or features of any embodiment may be combined in any way, unless these features are incompatible.

For the avoidance of doubt, the terms “can”, “and/or”, “for example”, “for example” [sic: repeated expression] and any other similar term used herein must be interpreted as not limiting, such that any feature described herein is not necessarily required to be present. Indeed, any combination of optional features is expressly foreseen without departing from the scope of the invention, whether or not they are expressly claimed. The applicant reserves the right to amend any claim originally filed or to file any new claim accordingly, including the right to amend any claim originally filed to depend on and/or incorporate any feature of any other claim, though it is not originally claimed in this manner.

### BRIEF DESCRIPTION OF THE DRAWINGS

Other features and advantages of the invention will become apparent from the following detailed description, which will be understood in reference to the appended drawings, in which:

FIG. 1 illustrates a cooking appliance according to the invention;

FIG. 2 illustrates a home screen displayed on the user interface of the cooking appliance in FIG. 1;

FIG. 3 illustrates a target core temperature menu displayed on the user interface;

FIG. 4 illustrates two tables of target core temperature ranges associated with parameters of a product to be cooked;

FIG. 5 illustrates the target core temperature menu in FIG. 3 showing a suggested target core temperature associated with a first selection of product parameters;

FIG. 6 illustrates the target core temperature menu in FIG. 3 showing a suggested target core temperature associated with a second selection of product parameters; and

FIG. 7 illustrates the target core temperature menu in FIG. 3 showing a suggested target core temperature associated with a third selection of product parameters.

### DETAILED DESCRIPTION

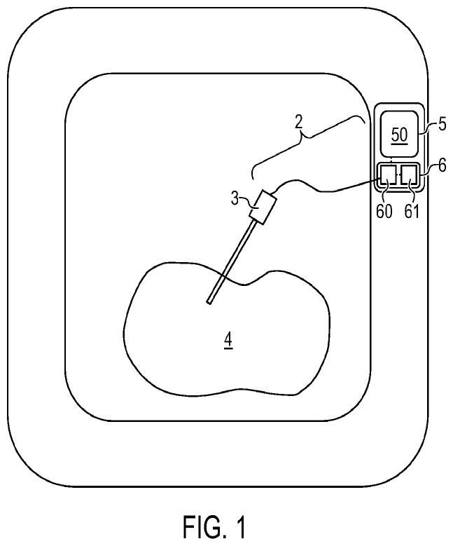

Different aspects of different embodiments of the invention are described in more detail below, in reference to FIGS. 1 to 7.

Referring to FIG. 1, a cooking appliance 1 comprising a control system 2 can be seen. The control system 2 comprises a core probe 3 for measuring a core temperature of an item to be cooked 4, a user interface 5 and a controller 6 operationally connected to the core probe 3 and to the user interface 5. The controller 6 comprises a memory 60 and a processor 61 operationally connected to the memory 60.

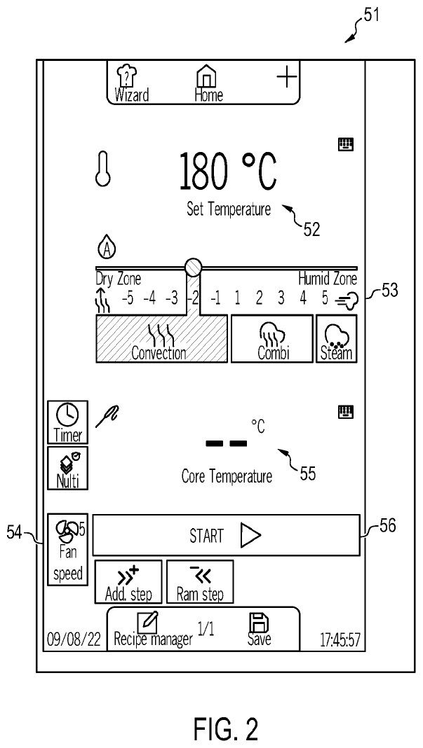

The user interface 5 comprises a touch screen 50 configured to display information and graphical input means to enable a user to enter information and prompts. FIG. 2 illustrates a home screen 51 displayed on the touch screen 50. The home screen 51 comprises a plurality of selectable cooking parameters 52, 53, 54, 55, such as the ambient temperature of the cooking appliance 52, the humidity of the cooking appliance 53, the speed of the fan 54 and the core temperature 55.

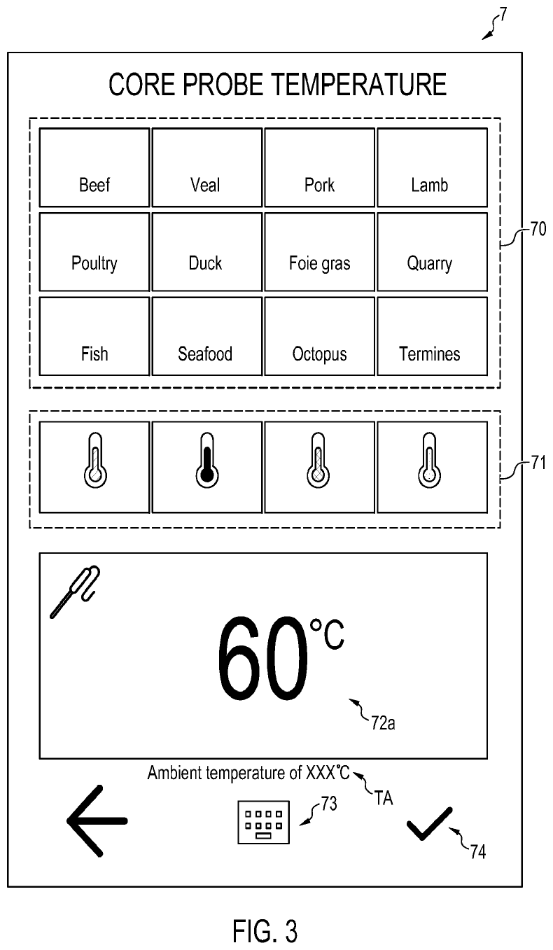

Selecting the core temperature parameter 55 opens a target core temperature menu 7, more clearly illustrated in FIG. 3. The target core temperature menu 7 comprises a plurality of icons 70, 71 to be selected by a user. The icons 70, 71 comprise a first series of icons 70 each representing a respective type of food and a second series of icons 71 each representing a degree of doneness. The target core temperature menu 7 also comprises an AT indicator for the user-selected ambient temperature of the cooking appliance 52.

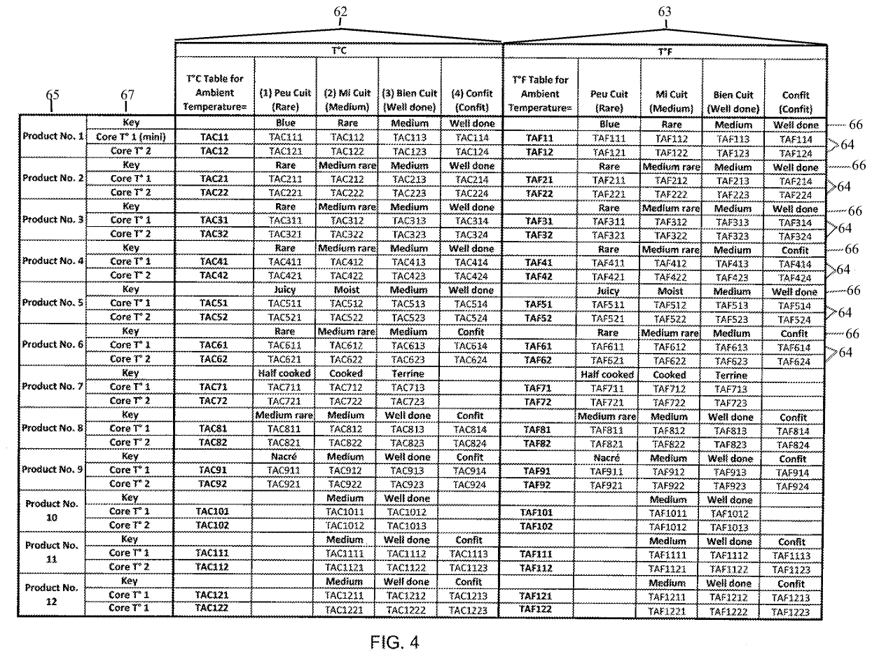

Now referring to FIG. 4, a plurality of tables are shown. A plurality of tables 62, 63 are stored in the memory 60, two of which are shown in FIG. 4. Each table 62, 63 comprises target core temperature ranges 64 each associated with a combination of product parameters 65, 66. Each table 62, 63 also comprises cooking parameter ranges 67, each associated with one of the first product parameters 65.

The first series of icons 70 displayed in the target core temperature menu 7 corresponds to the first product parameters 65, listed along the first two columns. The second series of icons 71 displayed in the target core temperature menu 7 corresponds to the second product parameters 66, listed along the rows. As shown, the second product parameters 66, representing the degree of doneness, vary according to certain first product parameters 65, representing the type of food. In this example, the cooking parameter ranges 67 correspond to the ambient temperature value ranges of the cooking appliance 52.

The control system 2 can be configured to automatically determine its location, for example whether it is in France, the United Kingdom or the United States. Based on this determination, the control system 2 can be configured to automatically select the appropriate table 62, 63 and the language in the table. Alternatively, the appropriate table 62, 63 can be selected by a user.

In response to the selection of one of the icons 70 in the first series, the processor 61 is configured to extract the second series of icons 71 from the selected table 62, 63 and display them on the core temperature menu 7. The second series of icons 71 corresponds to the second product parameters 66 associated with the first product parameter 65 corresponding to the selected icon 70. In response to the selection of one of the icons 71 in the second series, the processor 61 is configured to retrieve from the selected table 62, 63 a target core temperature range 64 associated with the two selected icons 70, 71.

In one example, the processor 61 determines the suggested target core temperature 72 by selecting the appropriate value within the target core temperature range 64 that corresponds to the user-selected ambient temperature of the cooking appliance 52. More specifically, the minimum and maximum values of the target core temperature range 64 correspond respectively to the minimum and maximum values of the cooking parameter range 67.

In this example, the relationship is linear, and the processor therefore calculates the suggested target core temperature 72 from the target core temperature range 64 using the user-selected ambient temperature of the cooking appliance 52. In other examples, the relationship can be non-linear and regulated by a predetermined formula. In other examples, the cooking parameter range 67 corresponds to one of the other cooking parameters 53, 54, 55 selected on the home screen 51 before the target core temperature menu 7 opens.

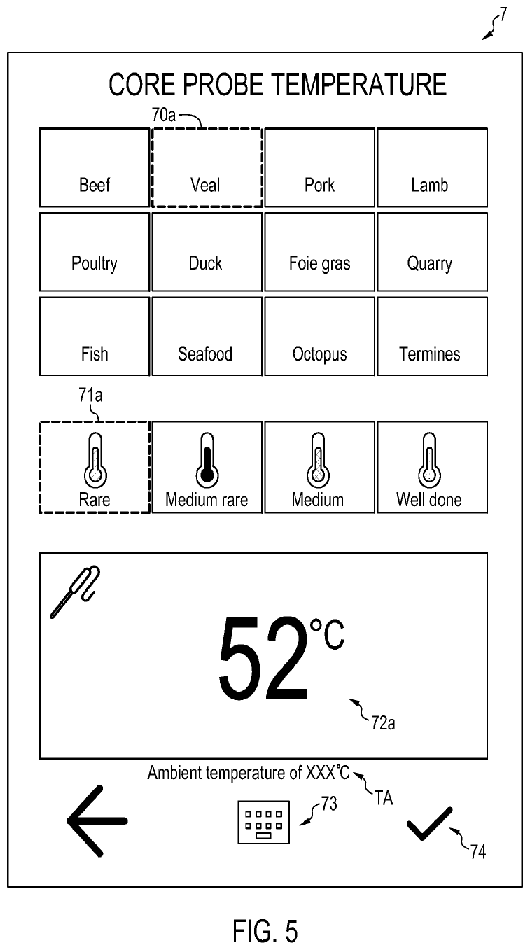

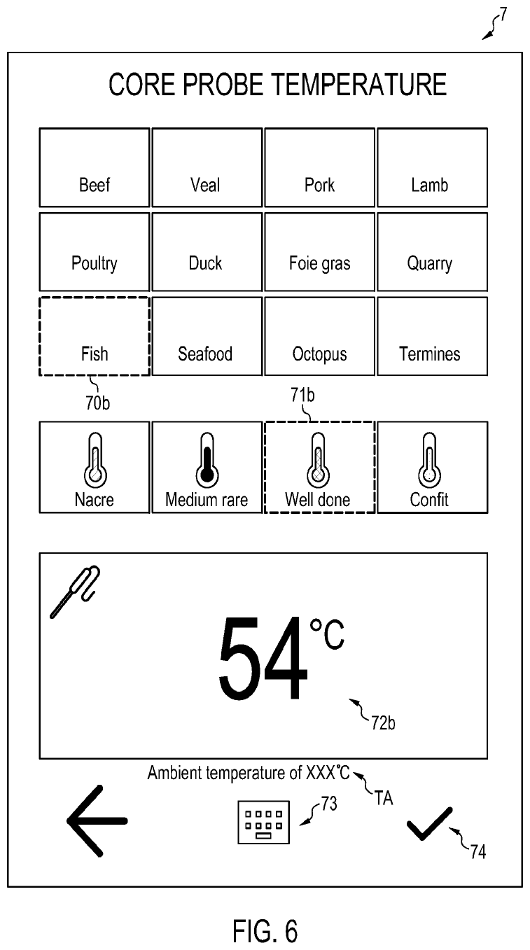

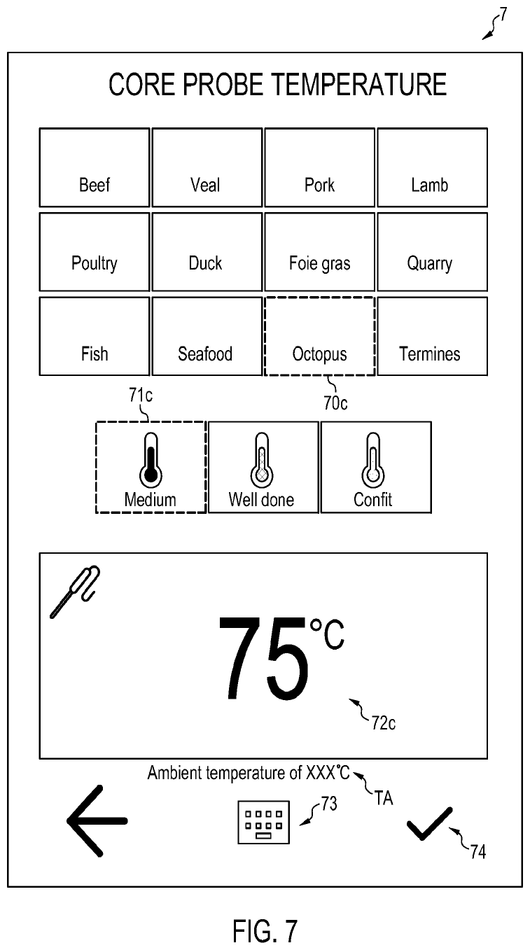

FIGS. 5, 6 and 7 illustrate three examples of the core temperature menu 7 showing a suggested target core temperature 72 corresponding to different selections of icons 70, 71. In FIG. 5, a suggested target core temperature 72a of 52° C. is shown for a combination of the veal icon 70a and the rare icon 71a. In FIG. 6, a suggested target core temperature 72b of 54° C. is shown for a combination of the fish icon 70b and the well done icon 71b. In FIG. 7, a suggested target core temperature 75° C. is shown for a combination of the octopus icon 70b and the medium icon 71b.

Once the suggested target core temperature 72, 72a, 72b, 72c is indicated, the user can adjust the suggested target core temperature value 72, 72a, 72b, 72c by selecting the touchpad icon 73 and entering the desired value. Once the user is satisfied with the temperature value displayed, the temperature value is set by selecting the accept icon 74. This closes the target core temperature menu 7, so that the home screen 51 is displayed. The cooking cycle can then be started by selecting the start icon 56.

Advantageously, the AT indicator can change color as a warning if any of the selected temperatures are outside the recommended range. For example, if the ambient temperature of the cooking appliance 52 is outside the cooking parameter range 67 for the selected food type 65, the AT indicator may change to red. Other AT indicator changes are also under consideration.

In some examples, the home screen 51 comprises a user login function for entering user information, such as a user ID and password. For instance, the user interface 5 can enable the home screen 51 to be customized and/or the target core temperature menu 7 can include an additional icon to enable the adjusted temperature value to be saved in a user-specific table 62, 63.

Other solutions can also be considered. Indeed, a person skilled in the art will be aware that several variants of the aforementioned embodiments are conceivable without departing from the scope of the invention.

Throughout the description and claims of this specification, the words “comprise” and “contain” and their variations mean “including but not limited to” and are not intended for (and do not exclude) other parts, additives, components, integers or steps. Throughout the description and claims of this specification, the singular includes the plural, unless the context requires otherwise. In particular, when the indefinite article is used, the specification should be understood to include the plural as well as the singular, unless the context requires otherwise.

Any features, integers, characteristics, compounds or groups described in connection with a particular aspect, embodiment or example of the invention are to be understood as being applicable to any other aspect, embodiment or example described herein, unless inconsistent therewith. All of the features disclosed in this specification (including the claims, abstract and accompanying drawings), and/or all of the steps of a method or of a process thus disclosed, may be combined in any combination other than combinations in which at least some of such features and/or steps are mutually exclusive. The invention is not limited to the details of all of the preceding embodiments. The invention extends to any new feature or any new combination of the features disclosed in this specification (including the claims, abstract and accompanying drawings), or to any new feature or any new combination of the steps of any method or process thus disclosed.

The reader's attention is drawn to all papers and documents that are filed concurrently or prior to this specification in connection with this application and that are open for public inspection with this specification, and the content of all such papers and documents is incorporated herein by reference.

1. A method for setting a target core temperature in a control system of a cooking appliance, the method comprising:
receiving, via a user interface on the control system, one or more product parameters for an item to be cooked;
displaying, via the user interface, a suggested target core temperature that is determined at least in part from the one or more product parameters received via the user interface.

2. The method according to claim 1, comprising:
receiving, via the user interface a first of the product parameters for an item to be cooked;
displaying, via the user interface a series of possible second product parameters based on the first product parameter; and
receiving, via the user interface, a selection of one in the series of possible second product parameters.

3. The method according to claim 2, comprising:
receiving, via the user interface a cooking parameter; and
determining the suggested target core temperature based on the cooking parameter and/or on the product parameter(s) received via the user interface.

4. The method according to claim 3, in which the first product parameter corresponds to a type of food, the second product parameter corresponds to a degree of doneness and the cooking parameter comprises an ambient temperature of the cooking appliance.

5. The method according to claim 4, comprising:
determining a target core temperature range associated with the product parameters received via the user interface; and
determining the suggested target core temperature by determining a value in the target core temperature range that corresponds to the ambient cooking appliance temperature.

6. The method according to claim 1, comprising:
receiving, via the user interface, an adjustment of the suggested target core temperature; and
displaying, via the user interface, an adjusted target core temperature based on the adjustment received via the user interface.

7. The method according to claim 1, comprising:
receiving, via the user interface, an acceptance of the target core temperature displayed;
receiving a prompt via the user interface to start a cooking cycle; and
starting, in response to the prompt, a cooking cycle based on the accepted target core temperature.

8. A cooking appliance control system comprising:
a core probe for measuring a core temperature of an item to be cooked;
a user interface used to receive inputs from a user and to display information; and
a controller operationally connected to the core probe and/or to the user interface;
in which the controller is configured for:
receiving, via the user interface, one or more product parameters for an item to be cooked; and
displaying, via the user interface, a suggested target core temperature that is determined at least in part from the one or more product parameter received via the user interface.

9. The cooking appliance control system according to claim 8, in which the controller is configured for:
receiving, via the user interface a first of the product parameters for an item to be cooked;
displaying, via the user interface, a series of possible second product parameters based on the first product parameter; and
receiving, via the user interface, a selection of one in the series of possible second product parameters.

10. The cooking appliance control system according to claim 9, in which the controller is configured for:
receiving, via the user interface a cooking parameter; and
determining the suggested target core temperature based on the cooking parameter and/or on the product parameter(s) received via the user interface.

11. The cooking appliance control system according to claim 10, in which the first product parameter corresponds to a type of food, the second product parameter corresponds to a degree of doneness and the cooking parameter comprises an ambient temperature of the cooking appliance.

12. The cooking appliance control system according to claim 9, in which the controller is configured for:
retrieving a target core temperature range associated with the product parameters received via the user interface; and
determining the suggested target core temperature by determining a value in the target core temperature range that corresponds to the ambient cooking appliance temperature.

13. The cooking appliance control system according to claim 8, in which the controller is configured for:
receiving, via the user interface, an adjustment of the suggested target core temperature; and
displaying, via the user interface, an adjusted target core temperature based on the adjustment received via the user interface.

14. The cooking appliance control system according claim 8, in which the controller is configured for:
receiving, via the user interface, an acceptance of the target core temperature displayed;
receiving a prompt via the user interface to start a cooking cycle; and
starting, in response to the prompt, a cooking cycle based on the accepted target core temperature.

15. A cooking appliance control system according to claim 8, in which the user interface comprises a touch screen configured to display a plurality of icons each representing a respective product parameter for selection by a user and/or an indicator (AT) of the user-selected ambient temperature of the cooking appliance.
